(19) United States
(12) Patent Application Publication
(10) Pub. No.: US 2009/0251720 A1
(43) Pub. Date: Oct. 8, 2009

(54) METHOD AND APPARATUS FOR PRINT JOB MANAGEMENT

(75) Inventors: Jonathan David LEVINE, Rochester, NY (US); Michael J. Evan, Webster, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/062,603

(22) Filed: Apr. 4, 2008

(51) Int. Cl. G06K 15/00

(52) U.S. Cl. 358/1.15

(57) ABSTRACT

A method and apparatus for managing print jobs for a printer is disclosed. The method may include receiving image data for printing a print job, the print job having more than one page and including one or more document and the image data being received only one time for each print job, receiving a signal to print the print job, wherein the received signal indicates that at least one page of the print job is to be printed in a different quantity than other pages in the print job, and printing the print job according to the received signal.

### BACKGROUND

Disclosed herein are a method and apparatus for print job management, as well as corresponding apparatus and computer-readable medium.

Print workflow operators often need to specify a different quantity for each set in a print job (collated or uncollated). For example, print jobs requiring subset quantity printing may be found in school districts that daily print the same teaching materials for each class in a grade, where each teacher gets a different quantity based on their class size. While printer operators can do the printing and organizing manually by submitting a different job for each uncollated set, this conventional process is a time-consuming and unwieldy approach and requires the submission of files that are much larger than necessary.

### SUMMARY

A method and apparatus for managing print jobs for a printer is disclosed. The method may include receiving image data for printing a print job, the print job having more than one page and including one or more document and the image data being received only one time for each print job, receiving a signal to print the print job, wherein the received signal indicates that at least one page of the print job is to be printed in a different quantity than other pages in the print job, and printing the print job according to the received signal.

### BRIEF DESCRIPTION OF THE DRAWINGS

FIG. 1 illustrates an exemplary diagram of a printing system in accordance with one possible embodiment of the disclosure;

FIG. 2 illustrates a block diagram of a print job management device in accordance with one possible embodiment of the disclosure;

FIG. 3 is a flowchart of an exemplary print job management process in accordance with one possible embodiment of the disclosure;

FIG. 4 is a flowchart of another exemplary print job management process in accordance with one possible embodiment of the disclosure; and

FIG. 5 is an exemplary print job ticket in accordance with one possible embodiment of the disclosure.

### DETAILED DESCRIPTION

Aspects of the embodiments disclosed herein relate to a method for print job management for a printer, and corresponding apparatus and computer readable medium. In this manner, a user may be allowed to specify the quantity of each page (or page range) to be printed. The user may also process multiple sub-print jobs to be run as one print job with a different quantity specified for each sub-print job. This process may be performed by enabling different quantities for subsections of a multi-page file, namely either a single original file or a single file joined from multiple files.

For a collated job with a single file, the user may manually or programmatically send the quantity of each collated page (or page range) or the user may specify the quantities in a job ticket. The default quantity for each page may be set to equal 1 if a value is not specified; this is the normal value for pages in a collated job. The number of collated sets in the job may be separate from each page's quantity. The default quantity for each page may be 1, which may be the normal value for pages in a collated job.

For an uncollated job, the customer may manually or programmatically send a quantity for the job (or the user may specify the uncollated quantity). This quantity may be given to all the pages in the job (this is how an uncollated job normally works). A machine process or the user may specify a different quantity for any of the pages (or range of pages) in the original file, for example. The default quantity for each page may be the default quantity for the uncollated job.

For a print job's file that has been joined together from multiple files, if the pages in the original files have quantities, these quantities may be retained after the original files are joined. This may be an important consideration for continuous feed printing because it enables a continuous feed device to efficiently run short-run print jobs, for example.

Print job quantity programming may be set to not override page-level quantity programming. For example, if the user (or machine process) has programmed any of the pages in a print job to have an exception quantity, and then the user (or machine process) changes the copy quantity for the entire job, that user change may not alter the exception quantities programmed for the individual pages. A special reset option may allow the user (or machine process) to set all exception page quantities to their default value.

As an example of a collated print job, the user may have the following original 4-page file. In this example, the user may want 100 collated sets and wants the listed quantities in the printed output in the following manner:
Page 1: Work Order—Quantity 1 (printed once at the beginning of the job)
Page 2: Packing Slip—Quantity 1 (printed once at the beginning of the job)
Page 3: Cover Sheet—Quantity 1 (in each set printed)
Page 4: The content of the job—Quantity 500 (in each set printed)

For the collated job, the job quantity may describe how many sets of 1 cover sheet plus 500 content sheets may be required in this manner:
The job may be programmed for 100 sets
Pages 1 and 2 are programmed as banner pages which may appear only once at the beginning of the 100 sets
Page 3 may be programmed for quantity 1
Page 4 may be programmed for quantity 500

The output may look like this:

| | |
|---|---|
| | Banner page (Work Order) |
| | Banner page (Packing Slip) |
| | 1 cover sheet |
| | 500 content sheets |
| | 1 cover sheet |
| . | 500 content sheets |
| . | |
| . | |
| | . |
| | . |
| | . |

As an example of an uncollated print job, the user may have the following original 4-page file. The user may want the listed quantities in the printed output in this manner:
Page 1: Work Order—Quantity 1 (printed once at the beginning of the job)
Page 2: Packing Slip—Quantity 1 (printed once at the beginning of the job)
Page 3: Cover Sheet 1—Quantity 1 (in each set printed)
Page 4: 1st Job Content Page—Quantity 500 (in each set printed)
Page 5: Cover Sheet 2—Quantity 1 (in each set printed)
Page 6: 2nd Job Content Page—Quantity 500 (in each set printed)

For the uncollated job, the job quantity may describe how many prints of the cover sheets and job content pages will normally be processed:
The (uncollated) job quantity may be set to 500 (this sets all pages in the job to quantity 500)
Pages 1 and 2 may be programmed as banner pages, and appear only once at the beginning of the printed output
Page 3 (Cover sheet 1) may be programmed for quantity 1
Page 5 (Cover sheet 2) may be programmed for quantity 1
Job content pages 4 and 6 may have already been set to 500
NOTE: If the user changes the job quantity, any pages that have their quantities already programmed as exceptions may not change. For convenience, a user-selectable operation, “reset all exception page quantities,” may be provided.

The output may look like this:

Banner page (Work Order)
Banner page (Packing Slip)
1 of Cover Sheet 1
500 of the First job Content Page
1 of Cover Sheet 2
500 of the Second job Content Page

This process may significantly reduce the file size of original documents (documents input to the print process). Reducing duplication in the original file may have many advantages:
Smaller file size may result in faster job transfer times and faster RIP times (e.g. in the collated example, 500 copies of the content page may be required in the original without subset quantity printing)
Fewer original pages may simplify, and therefore shorten the time required to produce the original document
In jobs where the output contains multiple copies of a single page, eliminating duplicate versions of that page in the original may result in fewer errors in the original document (e.g. the kinds of errors that occur when the document creator changes one of the duplicated pages but forgets to change the others)

Example applications of this process may include:
Insurance Industry: multiple copies of a form may be needed in a document
A two-page original containing a cover-letter and a form may be printed as a 6 page output set with one cover letter and 5 copies of the form (one for each family member)
Education: multiple copies of a standard worksheet may be needed for several classes of different sizes
A single job submission provides 23 copies of the worksheet to Class A, 14 copies to Class B, and 26 copies to Class C; the different sets may be divided by cover sheets
Pads (Graphic Arts): May enable a two-page original to produce one or more pads where the first page (the pad's cover sheet) may be different than the body of the pad (an arbitrary number of pages in the pad's body, which may be all the same)

The disclosed embodiments may include a method for managing print jobs for a printer. The method may include receiving image data for printing a print job, the print job having more than one page and including one or more document and the image data being received only one time for each print job, receiving a signal to print the print job, wherein the received signal indicates that at least one page of the print job is to be printed in a different quantity than other pages in the print job, and printing the print job according to the received signal.

The disclosed embodiments further include an apparatus that manages print jobs for a printer. The apparatus may include a communication interface that enables communications to the printer, and a print job management module that receives image data for printing a print job, the print job having more than one page and including one or more document and the image data being received only one time for each print job, receives a signal to print the print job, wherein the received signal indicates that at least one page of the print job is to be printed in a different quantity than other pages in the print job, and signals the printer to print the print job according to the received signal.

The disclosed embodiments further include a computer-readable medium that stores instructions for controlling a computing device for managing print jobs for a printer. The instructions may include receiving image data for printing a print job, the print job having more than one page and including one or more document and the image data being received only one time for each print job, receiving a signal to print the print job, wherein the received signal indicates that at least one page of the print job is to be printed in a different quantity than other pages in the print job, and printing the print job according to the received signal.

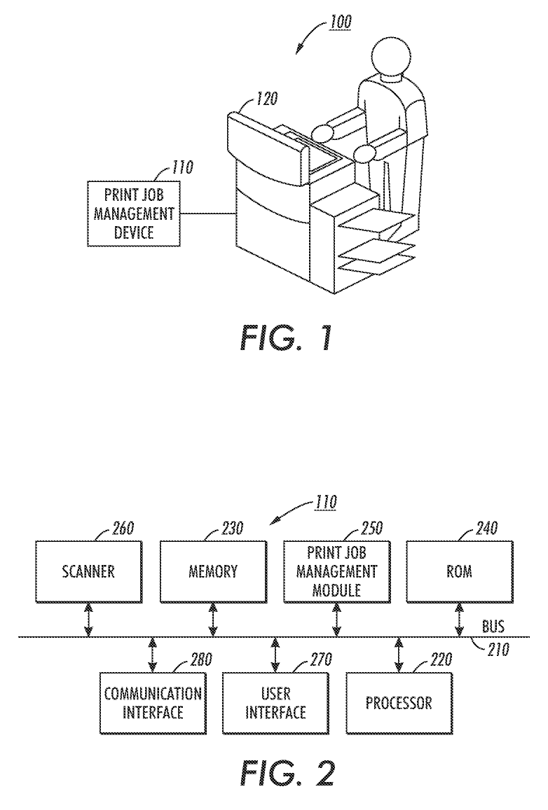

FIG. 1 illustrates an exemplary diagram of a printing system 100 in accordance with one possible embodiment of the disclosure. The printing system 100 may include a print job management device 110 and a printer 120. Note that the print management device 110 and the printer 120 may be located in the same device, such as the printer 120, or in separate devices. The print job management device 110 may communicate with the printer 120 either through a wired or a wireless connection, for example.

The print job management device 110 may represent any device capable of processing and managing print jobs, including a computer, a server, a personal digital assistant, another printer, etc., for example.

The printer 120 may represent any device (including a xerographic device) that may be capable of printing and/or making copies and processing large print jobs containing large numbers of documents, such as a stand-alone office printer, a commercial printer, a desktop printer, a large stand-alone office copier, a commercial copier, a desktop copier, a multi-function device (MFD), etc., for example. The printer 120 may also perform document finishing processes including stapling, hole punching, document orientation, color processing, and binding. The printer 100 may also be able to print in either black and white, color, or both in the same print job.

FIG. 2 illustrates a block diagram of a print management device 110 in accordance with one possible embodiment of the disclosure. The print management device 110 may include may include a bus 210, a processor 220, a memory 230, a read only memory (ROM 240, a print job management module 250, a scanner 260, a user interface 270, and a communication interface 280. Bus 210 may permit communication among the components of the print management device 110.

Processor 220 may include at least one conventional processor or microprocessor that interprets and executes instructions. Memory 230 may be a random access memory or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a local, remote or external network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

The user interface 270 may include one or more conventional input mechanisms that permit a user to input information, communicate with the print management device 110, and/or present information to the user, such as an electronic display, microphone, touchpad, keypad, keyboard, mouse, pen, stylus, voice recognition device, buttons, one or more speakers, etc. Output mechanisms for the user interface 270 may include one or more conventional mechanisms that output information to the user, including a display, a printer, one or more speakers, or a medium, such as a memory, or a magnetic or optical disk and a corresponding disk drive.

The scanner 260 may represent any scanner or scanning device known to those of skill in the art that may scan documents and/or images for processing.

The print management device 110 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The print management device 110 illustrated in FIGS. 1 and 2 and the related discussion are intended to provide a brief, general description of a suitable communication and processing environment in which the invention may be implemented. Although not required, the invention will be described, at least in part, in the general context of computer-executable instructions, such as program modules, being executed by the print management device 110, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including personal computers, hand-held devices, multi-processor systems, microprocessor-based or programmable consumer electronics, and the like.

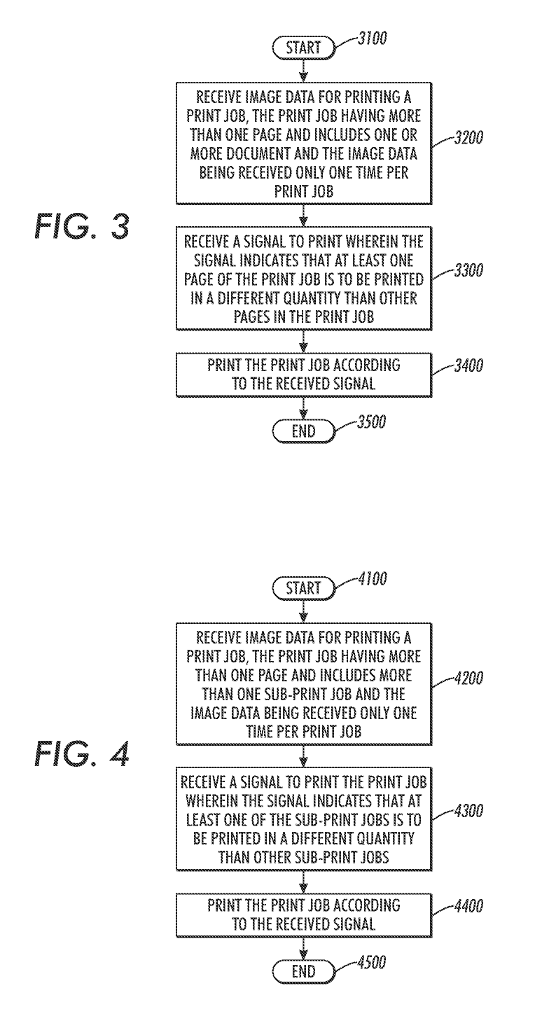

The operation of the print job management module 250 and the print job management process will be discussed further below in relation to FIGS. 3 and 4.

FIG. 3 is a flowchart of an exemplary print job management process in accordance with one possible embodiment of the disclosure. The process begins at step 3100, and continues to step 3200 where the print job management module 250 may receive image data for printing a print job. The print job may have more than one page and may include one or more document. The image data may be received only one time for each print job. Thus, the printer only has to process (or rip) the image data one time to produce the total print job.

At step 3300, the print job management module 250 may receive a signal to print the print job, wherein the received signal may indicate that at least one page of the print job is to be printed in a different quantity than other pages in the print job. The print management module 250 may prompt the user to enter a print job ticket. The print job ticket may indicate the number of pages for each document in the print job. The print job ticket may be created by the print job management device 110, and in particular, the print job management module that communicates with the printer 120 through the communication interface 280.

At step 3400, the print job management module 250 may print the print job according to the received signal. The print job management module 250 may also receive a signal to perform a document finishing process for at least one document in the print job. The document finishing process may include at least one of stapling, hole punching, document orientation, color processing, and binding. The process may also allow some documents or sub-print jobs of the print job to be printed in black and white while other documents or sub-print jobs may be printed in color, for example. The print job management module 250 may then perform the document finishing process according to the received signal. The process may then go to step 3500, and end.

Note that each document that is part of the print job may be a separate sub-print job and the signal may indicate that at least one sub-print job is to be printed in a different quantity than other sub-print job in the print job.

FIG. 4 is a flowchart of another exemplary print job management process having sub-print jobs in accordance with one possible embodiment of the disclosure. The process begins at step 4100, and continues to step 4200 where the print job management module 250 may receive image data for printing a print job. The print job may have more than one page and may include more than one sub-print job. The image data may be received only one time per print job. Thus, the printer only has to process (or rip) the image data one time to produce the total print job.

At step 4300, the print job management module 250 may receive a signal to print a print job. The signal may indicate that at least one of the sub-print jobs is to be printed in a different quantity than other pages in the other sub-print jobs. At step 4400, the print job management module 250 may print the print job according to the received signal. The process may then go to step 4400, and end.

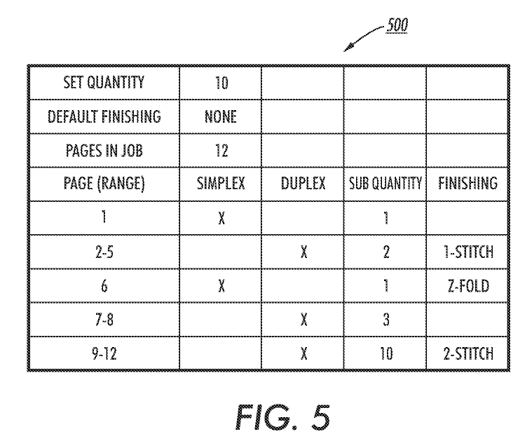

FIG. 5 is an exemplary print job ticket in accordance with one possible embodiment of the disclosure. The exemplary print job ticket illustrates a simple ticketing capability to produce the following from a 12 page document:

10 Sets each consisting of:

Page 1, simplex, qty 1

Page 2-5, duplex, qty 2, 1-Stitch

Page 6, simplex, qty 1, Z-Fold

Page 7-8, duplex, qty 3

Page 9-12, duplex, qty 10, 2-Stitch

While the input document only contained 12 pages the resultant total number of pages printed per set is 56. To produce this print job using conventional processes, the original document would have to contain all 56 pages. This would result in a significantly larger file which impacts performance in both the transmission to the print device as well as the processing (or rip) performance on the printer itself.

Using the disclosed technique, the printer only has to process (or rip) the 12 pages one time to produce the 56 page print job. Thus, the printer's performance and efficiency is improved.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for managing print jobs for a printer, comprising:
receiving image data for printing a print job, the print job having more than one page and including one or more document and the image data being received only one time for each print job;
receiving a signal to print the print job, wherein the received signal indicates that at least one page of the print job is to be printed in a different quantity than other pages in the print job; and
printing the print job according to the received signal.

2. The method of claim 1, wherein each document is a separate sub-print job and the signal indicates that at least one sub-print job is to be printed in a different quantity than other sub-print job in the print job.

3. The method of claim 2, further comprising:
prompting a user to enter a print job ticket, wherein the print job ticket indicates the number of pages for at least one of each document and each sub-print job in the print job.

4. The method of claim 3, wherein the print job ticket is created by a print job management device that communicates with the printer.

5. The method of claim 4, wherein the print job management device is one of a computer, a server, a personal digital assistant, and another printer.

6. The method of claim 1, further comprising:
receiving a signal to perform a document finishing process for at least one document in the print job, wherein the document finishing process is at least one of stapling, hole punching, document orientation, color processing, and binding; and
performing the document finishing process according to the received signal.

7. The method of claim 1, wherein the printer is one of a stand-alone office printer, a commercial printer, a desktop printer, a stand-alone office copier, a commercial copier, a desktop copier, and a multi-function device (MFD).

8. An apparatus that manages print jobs for a printer, comprising:
a communication interface that enables communications to the printer; and
a print job management module that receives image data for printing a print job, the print job having more than one page and including one or more document and the image data being received only one time for each print job, receives a signal to print the print job, wherein the received signal indicates that at least one page of the print job is to be printed in a different quantity than other pages in the print job, and signals the printer to print the print job according to the received signal.

9. The apparatus of claim 8, wherein each document is a separate sub-print job and the signal indicates that at least one sub-print job is to be printed in a different quantity than other sub-print job in the print job.

10. The apparatus of claim 9, wherein the print job management module prompts a user to enter a print job ticket, wherein the print job ticket indicates the number of pages for at least one of each document and each sub-print job in the print job.

11. The apparatus of claim 10, wherein the print job management module creates the print job ticket and sends the print job ticket to the printer using the communication interface.

12. The apparatus of claim 8, wherein the apparatus is included in one of a computer, a server, a personal digital assistant, and another printer.

13. The apparatus of claim 8, wherein the print job management module receives a signal to perform a document finishing process for at least one document in the print job, wherein the document finishing process is at least one of stapling, hole punching, document orientation, color processing, and binding, and signals the printer to perform the document finishing process according to the received signal.

14. The apparatus of claim 8, wherein the printer is one of a stand-alone office printer, a commercial printer, a desktop printer, a stand-alone office copier, a commercial copier, a desktop copier, and a multi-function device (MFD).

15. A computer-readable medium storing instructions for controlling a computing device for managing print jobs for a printer, the instructions comprising:
receiving image data for printing a print job, the print job having more than one page and including one or more document and the image data being received only one time for each print job;
receiving a signal to print the print job, wherein the received signal indicates that at least one page of the print job is to be printed in a different quantity than other pages in the print job; and
printing the print job according to the received signal.

16. The computer-readable medium of claim 15, wherein each document is a separate sub-print job and the signal indicates that at least one sub-print job is to be printed in a different quantity than other sub-print job in the print job.

17. The computer-readable medium of claim 16, the instructions further comprising:
prompting a user to enter a print job ticket, wherein the print job ticket indicates the number of pages for at least one of each document and each sub-print job in the print job.

18. The computer-readable medium of claim 17, wherein the print job ticket is created by a print job management device that communicates with the printer.

19. The computer-readable medium of claim 18, wherein the print job management device is one of a computer, a server, a personal digital assistant, and another printer.

20. The computer-readable medium of claim 15, the instructions further comprising:
receiving a signal to perform a document finishing process for at least one document in the print job, wherein the document finishing process is at least one of stapling, hole punching, document orientation, color processing, and binding; and
performing the document finishing process according to the received signal.
